(19) United States
(12) Patent Application Publication
(10) Pub. No.: US 2011/0299605 A1
(43) Pub. Date: Dec. 8, 2011

(54) METHOD AND APPARATUS FOR VIDEO RESOLUTION ADAPTATION

(75) Inventors: Douglas Scott PRICE, San Jose, CA (US); Xiaosong ZHOU, Campbell, CA (US); Hsi-Jung WU, San Jose, CA (US); James Oliver NORMILE, Los Altos, CA (US)

(73) Assignee: APPLE INC., Cupertino, CA (US)

(21) Appl. No.: 12/895,754

(22) Filed: Sep. 30, 2010

Related U.S. Application Data
(60) Provisional application No. 61/351,595, filed on Jun. 4, 2010.

(51) Int. Cl. H04N 7/26

(52) U.S. Cl. 375/240.26; 375/E07.2

(57) ABSTRACT

A system and method for gradually changing the resolution of a video signal to avoid a large spike in the video data transmitted between an encoder and a decoder. Upon detection of a change in the quality of source video, of the quality of the encoding process, or of the channel conditions, any of which may negatively impact the rate of frame transmission from encoder to decoder, or the quality of frames transmitted, a responsive change in the resolution of the video frame may be gradually implemented. To change the resolution by increasing the effective image size, each successive frame in a sequence of frames may contain additional pixel blocks in the expansion image area at the new resolution. In an embodiment, the decoder displays the video image at the original resolution until the resolution switch has been completed.

### CROSS REFERENCE TO RELATED APPLICATIONS

This application claims the benefit of priority to previously filed U.S. provisional patent application Ser. No. 61/351,595 (Attorney docket No. 13316/946900), filed Jun. 4, 2010, entitled VIDEO RESOLUTION ADAPTATION. That provisional application is hereby incorporated by reference in its entirety.

### BACKGROUND

Aspects of the present invention relate generally to the field of video processing, and more specifically to changing frame resolution across a plurality of frames.

In video coding systems, a conventional encoder may code a source video sequence into a coded representation that has a smaller bit rate than does the source video and, thereby achieve data compression. The encoder may include a pre-processor to perform video processing operations on the source video sequence such as filtering or other processing operations that may improve the efficiency of the coding operations performed by the encoder. The pre-processor may additionally separate the source video sequence into a series of frames, each frame representing a still image of the video. A frame may be further divided into blocks of pixels for ease of processing.

The encoder may code each frame of the processed video data according to any of a variety of different coding techniques to achieve bandwidth compression. Using predictive coding techniques (e.g., temporal/motion predictive encoding), some frames in a video stream may be coded independently (intra-coded I-frames) and some other frames may be coded using other frames as reference frames (inter-coded frames, e.g., P-frames or B-frames). P-frames may be coded with reference to a previous frame and B-frames may be coded with reference to previous and subsequent frames (Bi-directional). Reference frames may be temporarily stored by the encoder for future use in inter-frame coding.

The resulting compressed sequence (bitstream) may be transmitted to a decoder via a channel. When a new transmission sequence is initiated, the first frame of the sequence is an I-frame. Subsequent frames may then be coded with reference to other frames in the sequence by temporal prediction, thereby achieving a higher level of compression and fewer bits per frame as compared to I-frames. Thus, the transmission of an I-frame requires a relatively large amount of data, and subsequently requires more bandwidth that the transmission of an inter-coded frame.

The compressed bitstream may be received at the decoder, and original video data may be recovered from the bitstream by inverting the coding processes performed by the encoder, yielding a received decoded video sequence. The decoder may prepare the video for display by decompressing the frames of the received sequence, and by filtering, de-interlacing, scaling or performing other processing operations on the decompressed sequence that may improve the quality of the video displayed.

In some video coding systems, for example, in real time video communication systems, consistent quality and rate of frame transmission may be desired. Then changes in the channel conditions or source data conditions may require a change in picture resolution in order to maintain the necessary transmission rate and quality. In conventional video coding system, to change video resolution, a new sequence of frames at the alternate resolution must be initiated. Since initiating a new transmission sequence requires transmission of a new I-frame, the bit rate increases at the beginning of the sequence, which may result in an increase in network congestion. If channel conditions were affected by network congestion, and the deteriorating channel conditions were a contributing factor to requiring the resolution change in the first place, the resolution change itself can exacerbate the problem. Thus conventional video encoding systems do not provide a mechanism for efficient resolution change and the transition between resolutions may create a significant delay.

Accordingly, there is a need in the art for a video encoding system capable of rapidly responding to changes in the channel or source conditions by adjusting frame resolution, without adding significant delay to the real-time transmission of data and without significant increase in the bandwidth being used to transmit the video data over the channel.

### BRIEF DESCRIPTION OF THE DRAWINGS

The foregoing and other aspects of various embodiments of the present invention will be apparent through examination of the following detailed description thereof in conjunction with the accompanying drawing figures in which similar reference numbers are used to indicate functionally similar elements.

FIG. 1 is a simplified block diagram illustrating components of a video coding system according to an embodiment of the present invention.

FIG. 2 is a simplified block diagram illustrating components of an exemplary video encoder according to an embodiment of the present invention.

FIG. 3 illustrates a process of managing resolution change over a plurality of frames according to an embodiment of the present invention.

FIG. 4 is a simplified block diagram illustrating components of an exemplary video encoder according to an embodiment of the present invention.

FIG. 5 illustrates a process of managing resolution change over a plurality of frames according to an embodiment of the present invention.

FIG. 6 is a simplified block diagram illustrating components of an exemplary video decoder according to an embodiment of the present invention.

FIG. 7 is a simplified block diagram illustrating components of an exemplary video decoder according to an embodiment of the present invention.

FIG. 8 is a simplified flow diagram illustrating coding video data with a resolution change according to an embodiment of the present invention.

### DETAILED DESCRIPTION

Embodiments of the present invention provide a video coding system that scales image data to a programmable effective size prior to coding. When the effective image size changes from a first size to a second, larger size, the coding system generates a plurality of hybrid frames in which the effective image size gradually increases. The hybrid frames may include an inset containing a source image scaled according to the first size. Each hybrid frame may include an incrementally increased expanded image area having image content taken from the input image signal and scaled according to the second size. The hybrid frames may be coded and transmitted to a decoder. Upon coding of a final hybrid frame, the system may transmit a message to the decoder indicating that the second effective image size is available for use. Spreading over a plurality of hybrid frames the addition of pixel blocks that may be coded as I-blocks in order to change to the second image or frame size may allow the jump in bandwidth due to the I-coding of new pixel blocks to be distributed across multiple frames. Distributing the I-coded blocks across multiple frames may allow a minimal increase in bandwidth and thereby may have a limited impact on any congestion of the channel.

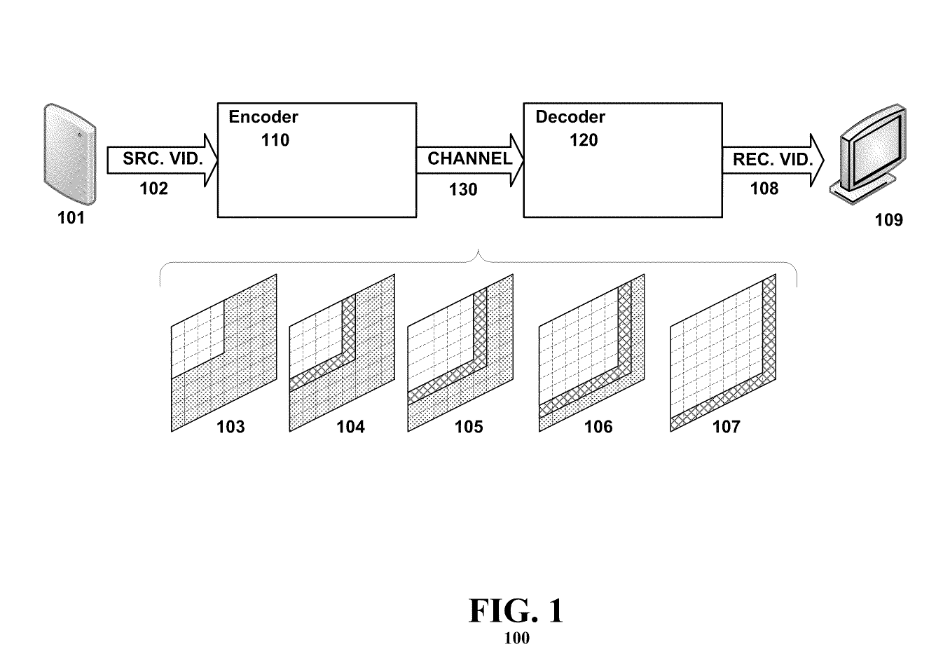

FIG. 1 is a simplified block diagram illustrating components of an exemplary video coding system 100 according to an embodiment of the present invention. As shown, the video coding system 100 may include an encoder 110 and a decoder 120. The encoder may receive an input source video sequence 102 from a video source 101, such as a camera or storage device. As will be further explained, the encoder 110 may then process the input source video sequence 102 as a series of frames and dynamically adjust an effective size of the video image to match ambient conditions at the encoder. For example, as shown in the sequence of frames illustrated by frames 103-107, when a resolution change is initiated each frame in the sequence of frames may incrementally adjust the resolution by changing the number of pixels in each frame that contain image data, thereby changing the effective viewing area of the frame.

Using predictive coding techniques, the encoder 110 may compress the video data using a motion-compensated prediction technique that exploits spatial and temporal redundancies in the input source video sequence 101. The resulting compressed sequence may occupy less bandwidth than the source video sequence when it is transmitted to a decoder 120 via a channel 130. The channel 130 may be a transmission medium provided by communications or computer networks, for example either a wired or wireless network. Alternatively, the channel 130 may be embodied as storage media such as electrical, magnetic or optical storage devices.

The decoder 120 may receive the compressed video data from the channel 130 and prepare the video for the display 109 by inverting coding operations performed by the encoder 110. The processed video data 108 may be displayed on a screen or other display 109. Alternatively, it may be stored in a storage device (not shown) for later use. The decoder 120 further may prepare the decompressed video data for the display 109 by filtering, de-interlacing, scaling or performing other processing operations on the decompressed sequence that may improve the quality of the video displayed. The processing operations may include selecting the effective image size for the decoded frames such that the frames are displayed at the appropriate resolution.

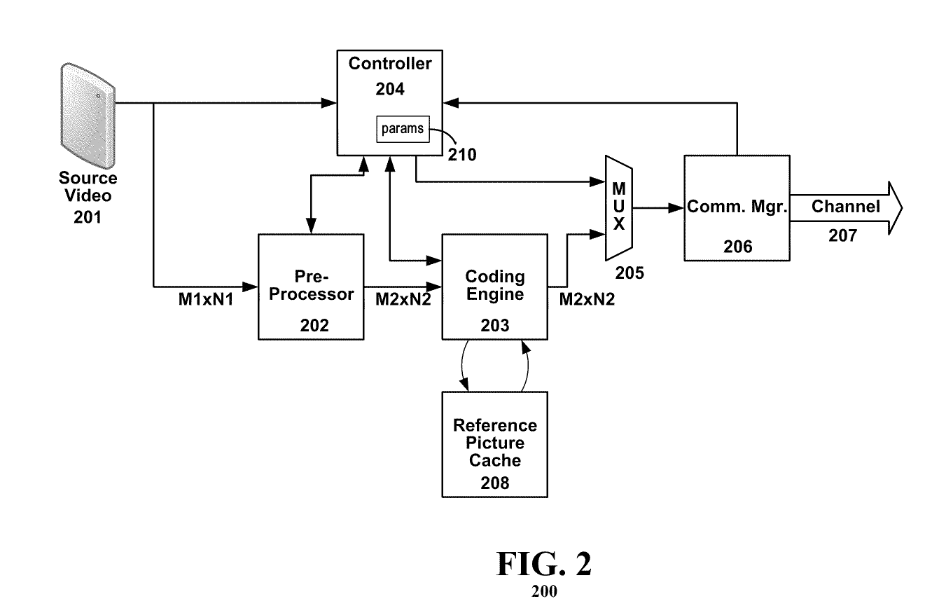

FIG. 2 is a simplified block diagram illustrating components of an exemplary video encoder 200 according to an embodiment of the present invention. As shown, encoder 200 may include a pre-processor 202, a coding engine 203 with a reference picture cache 208, a controller 204, a multiplexer (MUX) 205 and a communications manager 206.

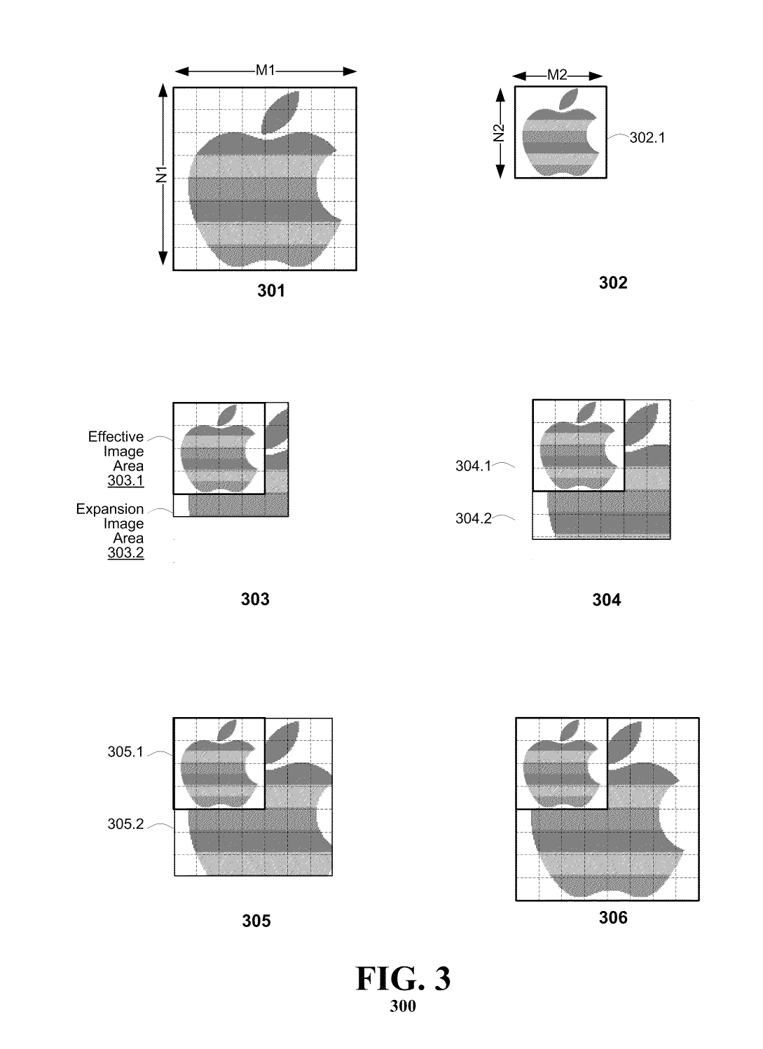

The pre-processor 202 may perform video processing operations to condition the source video sequence 201 to render bandwidth compression more efficient or to preserve image quality in light of anticipated compression and decompression operations. The pre-processor 202 additionally may separate the source video sequence 201 into a series of frames, if not already done, each frame representing a still image of the video. For example, frame 301 of FIG. 3 is a simplified diagram of a single frame that may be prepared by the pre-processor 202. As shown in frame 301, a frame may be parsed into block based pixel arrays (“pixel blocks” herein) for ease of processing. The pre-processor 202 also may scale the source video to output processed video frames having a dynamically adjustable size.

The controller 204 may control operation of the pre-processor 202 and coding engine 203 by setting operational parameters 210 of each. For example, with respect to the coding engine 203, the controller 204 may set coding types for pixel blocks (e.g., I-, P- or B-coding), refresh rates for error resiliency, quantization parameters to be used for coefficient truncation, the sizes of images to be coded and the like. With respect to the pre-processor 202, the controller 204 may set parameters setting the types of filtering to be performed by the pre-processor 202 and relative strengths of filtering that should be applied and parameters of scaling operations.

In an embodiment, to change effective image size, the controller 204 may set parameters defining an effective size of a frame to be output by the pre-processor 202. The controller 204 may implement resolution changes in response to a variety of factors, including channel conditions, image content and operational conditions of the pre-processor 202, coding engine 203 and/or communications manager 206. In this regard, the controller 204 may receive source video data 201 from the source video, and feedback signals from the pre-processor 202, coding engine 203 and communications manager 206. Upon detection of conditions that would warrant a resolution change, the controller 204 may determine the desired effective frame size and provide instructions to the pre-processor 202 regarding the frame to be created and to the coding engine 203 regarding the frame to be coded.

In another embodiment, the controller 204 may determine to perform a change in effective frame size by receiving notification via the channel 207 or decoding statistics from the decoder. Then, once the size change is initiated, the controller 204 may provide instructions to the pre-processor 202 regarding the frames to be created and to the coding engine 203 regarding the frames to be coded.

The coding engine 203 may receive the processed video data from the pre-processor 202. The coding engine 202 may operate according to a predetermined protocol, such as H.263, H.264, or MPEG-2. In its operation, the coding engine 203 may perform various compression operations, including predictive coding operations that exploit temporal and spatial redundancies in the source video sequence 201. The coded video data, therefore, may conform to a syntax specified by the protocol being used.

The MUX 205 may then merge coded video data from the coding engine 203 with the frame instructions from the controller 204. The frame instructions may include information regarding frame resolution that may be used by a decoder. For example, when the encoder 200 has completed the resolution change, the frame instructions may include information the decoder may use to prepare the frames for display at the new resolution. Then, the frame instructions may be sent to the decoder after the encoder 200 has completed the resolution change. The frame instructions may then be sent to a decoder in logical channels established by the governing protocol for out-of-band data.

The communications manager 206 may be a controller that coordinates the output of the merged data to the communication channel 207. In an embodiment, where the coding engine 203 may operate according to the H.264 protocol, the frame instructions may be transmitted in a supplemental enhancement information (SEI) channel specified by H.264. In such an embodiment, the MUX 205 may introduce the frame instructions in a logical channel corresponding to the SEI channel. In another embodiment, the communications manager 206 may include such frame instructions in a video usability information (VUI) channel of H.264.

In yet another embodiment, if the coding engine 203 may operate according to a protocol that does not specify out-of-band channels, the MUX 205 and the communications manager 206 may cooperate to establish a separate logical channel for the frame instructions within the output channel.

FIG. 3 illustrates an embodiment of the present invention in which exemplary frame data that may be generated as the effective frame sizes are changed. During the change process, frame data may have two components: an effective image area and an expansion image area. The video coding system may process frames of variable sizes, shown in FIG. 3 as frames 301-306. During operation, the encoder may change the effective size of the frame to a size, for example from size M1×N1 (frame 301) to size M2×N2 (frame 302) and back to M1×N1. During steady state operational conditions, when the frame size is maintained at a stable level—either M1×N1 or M2×N2—the coding system may process frames at the current frame size.

When the frame size is to be increased from one size to another size (say, from M2×N2 to M1×N1), the system may generate and code composite frames 303-306 that include a constant effective image area 303.1 and a gradually increasing expansion image area 303.2. Frames 303-306 provide an example of a transition sequence that may be generated when the effective image area is changed from M2×N2 to M1×N1. In each of the composite frames 303-306, the effective image area remains of constant size but the overall frame size increases in accordance with the increasing expansion image area. In the first composite frame 303, an expansion image area 303.2 may be added to the frame. The expansion image area 303.2 may include a portion of the source image scaled according to the new effective image size (M1×N1 inthis case). The composite image need not include a null image area as the overall frame size may not be fixed. When the coding engine codes the composite frame 303, the image content of the expansion image area 303.2 may be coded as I-blocks if the coding engine likely may not find a suitable prediction reference among the previously coded data.

The next frame 304 may include an incrementally larger expansion image area 304.2 than the prior frame 303.2 but the effective image area 304.1 may remain the same size as the prior frames 302, 303. Again, the expansion image area 304.2 may include image content of the source image scaled to the final effective image area. When the composite frame 304 is coded by the coding engine, a portion of the expansion image area 304.2 corresponding to the increased size may be coded as I-blocks if the coding engine cannot find a suitable prediction reference among previously-coded data. The portion of the expansion image area 304.2 that overlaps the expansion image area 303.2 of the prior frame 303, however, likely can be coded by motion compensation prediction (say, P-blocks).

The remaining frames 305-306 may be coded in similar fashion. Each frame may be a composite image that includes the effective image area 305.1, 306.1 and an increasing expansion image area 305.2, 306.2. For each frame, a portion of the expansion image area 305.2, 306.2 that overlaps the expansion image areas of prior frames likely can be coded by motion compensation prediction (say, P-blocks or B-blocks). A portion of the expansion image area 305.2, 306.2 that is new as compared to the prior frames 303 and 304 likely will be coded as I blocks.

After the transition sequence reaches a state as shown in frame 306, where the effective image area 306.1 and the expansion area 306.2 collectively occupy the size of the new effective image area, the video coding system may start coding source frames that are scaled to the new effective image area. Thus, the next frame to be coded following frame 306 will be a frame with an effective image area at the new size (M1×N1), for example, a frame having the format as shown in frame 301. The portion of the M1×N1 sized frame that formerly was occupied by the effective image area 306.1 may be replaced by image content of the source frame scaled at the M1×N1 size. It is likely that this portion will be coded as I-block by the coding engine, unless a suitable prediction reference can be found from prior frames.

During operation, the encoder and decoder may exchange signaling to identify the effective image size and the total size of the frames. At the encoder, the pre-processor may scale source image data to fit the effective image area during stable operation (frames 301 or 302). The pre-processor further may scale source image data to the old and new effective image areas during the transition sequence and, further, may generate the composite images shown in frames 303-306.

At the decoder, the decoding engine may decode the images as coded by the encoder. Thus, the decoder may decode coded video data received from the channel and may generate recovered frames corresponding to the formats as shown in frames 301-306. The decoder may store these recovered frames in a reference picture cache as they are decoded for use in decoding subsequently received frames.

In an embodiment, a post-processor at the decoder may output an image to a display corresponding to the effective image area as identified in the channel. Thus, during stable operation (as in frame 301 or 302) the post-processor stores data identifying the effective image area of the frame. Based on this data, the post-processor may retrieve an output a portion of the received frames corresponding to this effective image size (M2×N2 in the example of frame 302).

During the transition sequence, the effective image size may remain unchanged. Thus, although the decoder receives and decodes frames up to a maximum image size (M1×N1), the post-processor outputs only the M2×N2 sized image to a display. The expansion image areas of frames 303-306 essentially are “hidden” from the display process.

Throughout the transition sequence, the encoder may identify the new sizes of the frames to the decoder. When the transition sequence is concluded, the encoder may communicate a revised effective image size to the decoder. The decoder should associate the revised size with the first frame having the format as shown in frame 301. At this point, the post-processor may retrieve and display video data at the revised effective image area.

The embodiment of FIG. 3 finds application in coding systems such as FIG. 2 in which the controller may have some control over a coding engine. For example, in some implementations, a coding system may provide the coding engine as an integrated circuit separate from the controller and/or pre-processor that accepts input image data at a size determined by the controller. Therefore, a null image area filling an unused portion of the standard frame may not be required. The embodiment of FIG. 3 may distribute the coding costs of changing among image sizes across a plurality of video frames rather than a single frame.

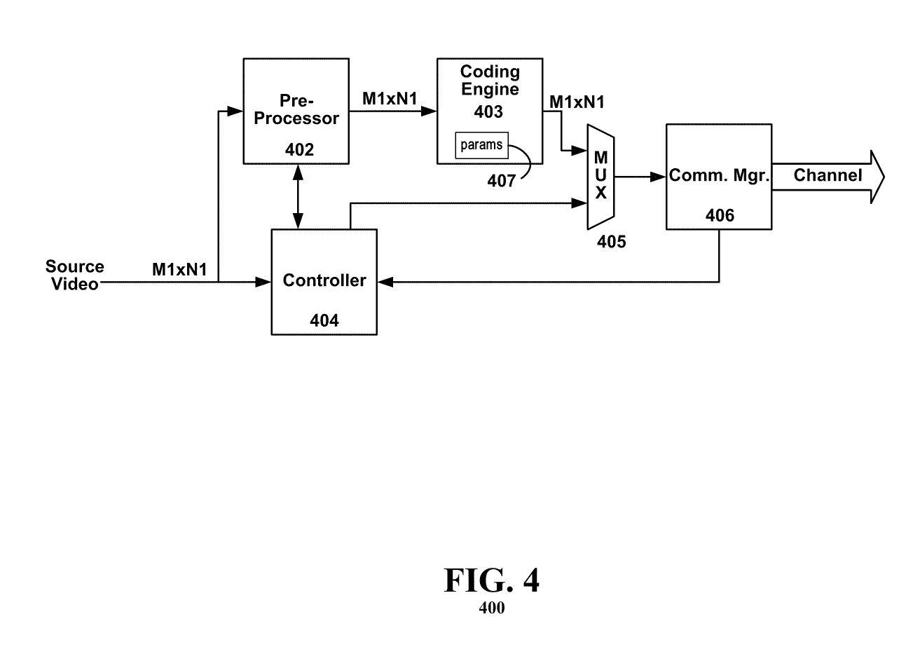

FIG. 4 is a simplified block diagram illustrating components of an exemplary video encoder according to an embodiment of the present invention. Similar to FIG. 2, the encoder 400 may include a pre-processor 402, a coding engine 403, a controller 404, a multiplexer (MUX) 405 and a communications manager 406.

As shown in FIG. 4, the coding engine 403 may receive the processed video data from the pre-processor 402. The coding engine 403 may operate according to a predetermined protocol, and perform various compression operations on the processed video data. The coding engine 403 may operate autonomously from the controller 404 and may select coding parameters based on parameter selection logic operating within the coding engine 403. The coding engine 403 may perform compression operations on the processed frames according to the protocols and compression algorithms that may be implemented at the coding engine 403 including any new pixel blocks added to a frame to adjust the size and resolution of the frame.

The controller 404 may control operation of the pre-processor 402 by setting operational parameters 407. For example, the types of filtering to be performed by the pre-processor 402 and relative strengths of filtering that should be applied and the parameters defining a size of an image to be output by the pre-processor 402. The controller 404 may control the size of frame output by the pre-processor 402 and may change the size in response to a variety of factors, including channel conditions, image content and operational conditions of the pre-processor 402, or the communications manager 406. To monitor those operational conditions, the controller 404 may receive feedback signals from the pre-processor 402 or the communications manager 406. Upon detection of conditions that would warrant a resolution change, the controller 404 may determine the desired frame size and resolution and provide instructions to the pre-processor 402 regarding the frame to be created. However, the controller 404 may not control operation of the coding engine 403 nor receive feedback signals from the coding engine 403. In yet another embodiment, the controller 404 may receive feedback signals from the coding engine 403 to monitor the operating procedures of the coding engine 403, but may not provide instructions to or otherwise control the coding engine 403.

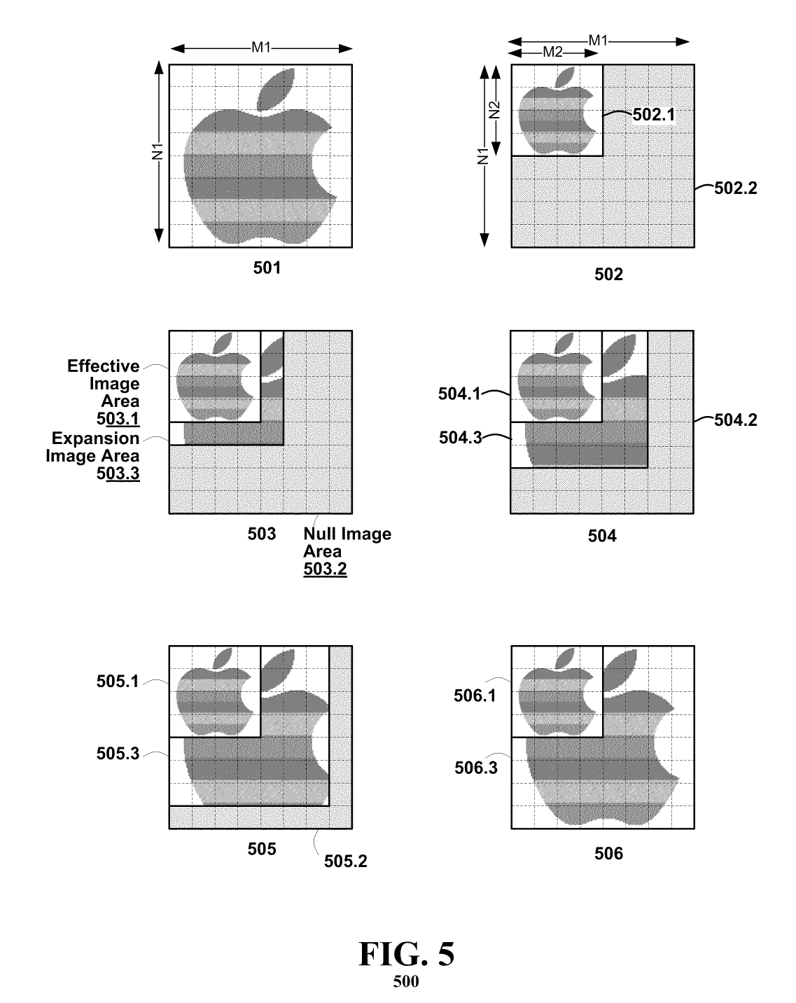

FIG. 5 illustrates an embodiment of the present invention in which exemplary frame data that may be generated as the effective frame sizes are changed. During the change process, frame data may have three components: an effective image area, a null image area and an expansion image area. The video coding system may process frames of a constant size, shown as M1×N1 in frame 501. During operation, the encoder may change the effective size of the frame to a second size (shown as M2×N2 as in frame 502) that is less than the maximum frame size. During steady state operational conditions, when the effective size is maintained at a stable level that is less then the predetermined maximum, the system may code and decode composite frames such as frame 502 that include an effective image area 502.1 and a null image area 502.2. As its name implies, null image area 502.2 has very low complexity image content; typically, it is provided as wholly black or wholly white image content. Coding of the null image area, therefore, should be extremely efficient in a video coder that performs a discrete cosine transform or wavelet transform. During stable operation, the null image area occupies a space of the frame 502 left unoccupied by the effective image area 502.1.

When the video coder changes the effective image area of the frame, it may generate frames that include the effective image area, a gradually increasing expansion image area and a gradually decreasing null image area. Frames 503-506 provide an example of a transition sequence that may be generated when the effective image area is changed from M2×N2 to M1×N1. In each of composite frames 503-506, the effective image area remains of constant size. In the first frame 503, an expansion image area 503.3 may be added to the frame. The expansion image area 503.3 may include a portion of the source image scaled according to the new effective image size (M1×N1 in this case). The null image area 503.2 may be decreased by a corresponding amount. When the composite frame 503 is coded by the coding engine, the image content of the expansion image area 503.3 is likely to be coded as I-blocks because the coding engine likely will not find a suitable prediction reference among the previously coded data. The null image area 503.2 of the frame should be coded extremely efficiently.

The next frame 504 may include an incrementally larger expansion image area 504.3 than the prior frame 503.3 but the effective image area 504.1 may remain the same size as the prior frames 502, 503. Again, the expansion image area 504.3 may include image content of the source image scaled to the final effective image area. When the composite frame 504 is coded by the coding engine, a portion of the expansion image area 504.3 corresponding to the increased size may be coded as I-blocks if the coding engine cannot find a suitable prediction reference among previously-coded data. The portion of the expansion image area 504.3 that overlaps the expansion image area 503.3 of the prior frame 503, however, likely can be coded by motion compensation prediction (say, P-blocks).

The remaining frames 505-506 may be coded in similar fashion. Each frame may be a composite image that includes the effective image area 505.1, 506.1, an increasing expansion image area 505.3, 506.3 and a decreasing null image area 505.2. In the example shown in FIG. 5, a final frame 506 in the transition sequence includes only an effective image area 506.1 and an expansion image area 506.2. The null image area of prior frames has been consumed. The null image area will not be consumed in all cases, however; if the final effective image size is smaller than the maximum possible value, a null image area will remain corresponding to a frame area that is not occupied by the revised effective frame size.

After the transition sequence reaches a state as shown in frame 506 where the effective image area 506.1 and the expansion area 506.2 collectively occupy the size of the new effective image area, the video coding system may start coding source frames that are scaled to the new effective image area. Thus, the next frame to be coded following frame 506 will be a frame with an effective image area at the new size (M1×N1), for example, a frame having the format as shown in frame 501.

During operation, the encoder and decoder may exchange signaling to identify the effective image size of the frames. At the encoder, the pre-processor may scale source image data to fit the effective image area during stable operation (frames 501 or 502). The pre-processor further may scale source image data to the old and new effective image areas during the transition sequence and, further, may generate the composite images shown in frames 503-506. The portion of the M1×N1 sized frame that formerly was occupied by the effective image area 506.1 may be replaced by image content of the source frame scaled at the M1×N1 size. It is likely that this portion will be coded as I-block by the coding engine, unless a suitable prediction reference can be found from prior frames.

At the decoder, the decoding engine may decode the images as coded by the encoder. Thus, the decoder may decode coded video data received from the channel and may generate recovered frames corresponding to the formats as shown in frames 501-506. The decoder may store these recovered frames in a reference picture cache as they are decoded for use in decoding subsequently received frames.

A post-processor at the decoder, in an embodiment, may output an image to a display corresponding to the effective image area as identified in the channel. Thus, during stable operation (for example, when received frames correspond to the format shown in frame 501 or 502), the post-processor may store data identifying the effective image area of the frame. Based on this data, the post-processor may retrieve an output a portion of the received frames corresponding to this effective image size (M2×N2 in the example of frame 502).

During the transition sequence, the effective image size may remain unchanged. Thus, although the decoder receives and decodes images at the maximum image size (M1×N1), the post-processor outputs only the M2×N2 sized image to a display. The expansion image areas of frames 503-506 essentially are “hidden” from the display process.

When the transition sequence is concluded, the encoder may communicate a revised effective image size to the decoder. The decoder should associate the revised size with the first frame having the format as shown in frame 501. At this point, the post-processor may retrieve and display video data at the revised effective image area.

The embodiment of FIG. 5 finds application in coding systems such as FIG. 4 in which the controller has limited control over a coding engine. For example, in some implementations, a coding system may provide the coding engine as an integrated circuit separate from the controller and/or pre-processor that accepts input image data of a fixed size (say, M1×N1). The controller can revise the effective image size and, consequently, the number of bits required to code the image even in situations where the controller cannot control the size of frames being coded by the coding engine.

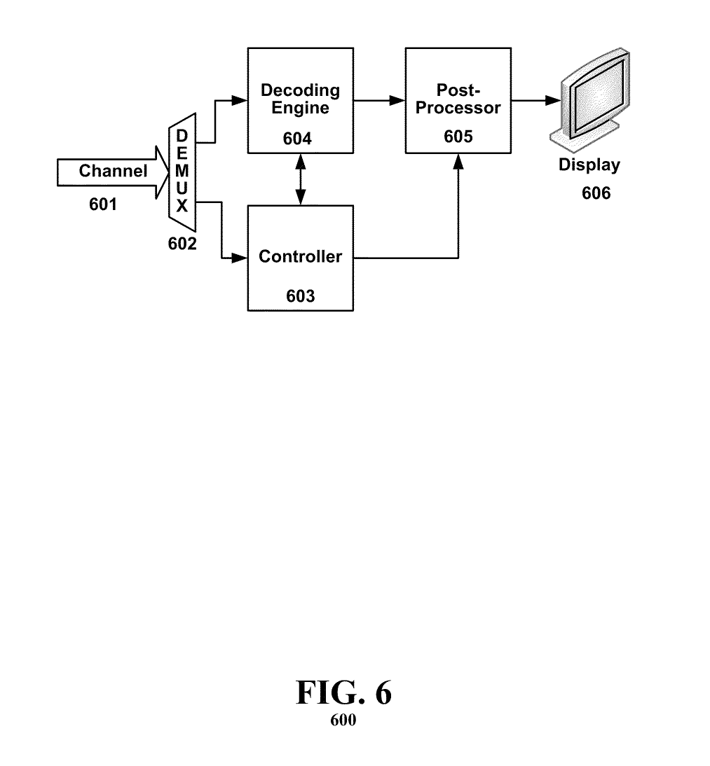

FIG. 6 is a simplified block diagram illustrating components of an exemplary video decoder according to an embodiment of the present invention. Decoder 600 may include a demultiplexer (DEMUX) 602, a decoding engine 604, a controller 603, and a post-processor 605.

The decoding engine 604 may receive the compressed video data from the channel 601 and prepare the video for display by decompressing the frames of the received video data. The decoding engine 604 may also acknowledge received frames and report lost frames to the encoder. Reference frames for use in inter-frame decoding may be temporarily stored in a frame store. The post-processor 605 may prepare the video data for display by filtering, de-interlacing, scaling or performing other processing operations on the decompressed sequence that may improve the quality of the video displayed.

The DEMUX 602 may be a controller implemented to separate the data received from the channel 601 into multiple logical channels of data thereby separating the frame instructions from the coded video data. As the frame instructions may be merged with the coded video data in numerous ways, the DEMUX 602 may be implemented to determine whether the received data uses a logical channel established by the governing protocol, the supplemental enhancement information (SEI) channel or the video usability information (VUI) channel specified by H.264 for example. Then DEMUX 602 may represent processes to separate the accumulated statistics from a logical channel corresponding to the SEI or VUI channel respectively. If the governing protocol does not specify out-of-band channels, the DEMUX 602 may cooperate with the controller 603 to separate the accumulated statistics from the coded video data by identifying a logical channel containing out-of-band data within the channel 601.

After the coded video data is separated from the frame instructions, the coded video data may be passed to the decoding engine 604. The decoding engine 604 may then parse the coded video data to recover the original source video data, for example, by decompressing the coded video data.

In an embodiment, the controller 603 may receive the frame instructions from the DEMUX 602 that indicate when the resolution has been switched. Then the controller 603 may have limited control of the decoding engine 604 and post-processor 605 by setting operational parameters of each. For example, with respect to the decoding engine 604, the controller 603 may set parameters defining the resolution of received frames, the size of the frames, the type of frame, or the location of constant black filled pixel blocks that need not be decoded.

With respect to the post-processor 605, the controller 603 may set parameters setting the size of the effective viewing area to be displayed, the portion of the frame available for display, or the pixel blocks that may be filled with constant black. When a resolution change is in progress, the controller 603 may instruct the post-processor 605 to display a portion of the received decoded frame, for example, the M2×N2 effective viewing area, or to use a M2×N2 portion of the frame to create an M1×N1 sized frame, either by upsizing or downsizing the M2×N2 portion to fit the M1×N1 sized frame, or by filling in the pixel blocks that make of the difference between the M2×N2 frame area and the M1×N1 sized frame. Then, upon receipt of a frame instruction indicating that the resolution change has been completed, the controller 603 may set the parameters such that the image is displayed at the new size and resolution.

In another embodiment the controller 603 may determine that the resolution has switched without reference to received frame instructions, by evaluating the decoded video data. For example, if any part of the full M1×N1 frame contains constant-filled black blocks, then the controller 603 may anticipate that a resolution switch is in progress. Then, the controller 603 may provide instructions to the post-processor 605 regarding the resolution, type of frame, and effective viewing area to be displayed as well as the action(s) to be taken, if any, to improve the video output in light of any received information. However, the controller 603 may not set any parameters or otherwise control the decoding engine 604 where the resolution switch has not yet been detected by the controller 603.

The post-processor 605 may receive both the decompressed video data from the decoding engine 604 and frame instructions from the controller 603, and then perform operations to condition the decoded video data to be rendered on a display. In the instructions provided to the post-processor 605, the controller 603 may indicate when the M2×N2 effective viewing area may be shown, and when the switch may be made to the full M1×N1 frame. The controller 603 may also indicate whether additional blurring, or filtering, is required to smooth the transition from the display of the M2×N2 sized image to the M1×N1 sized image.

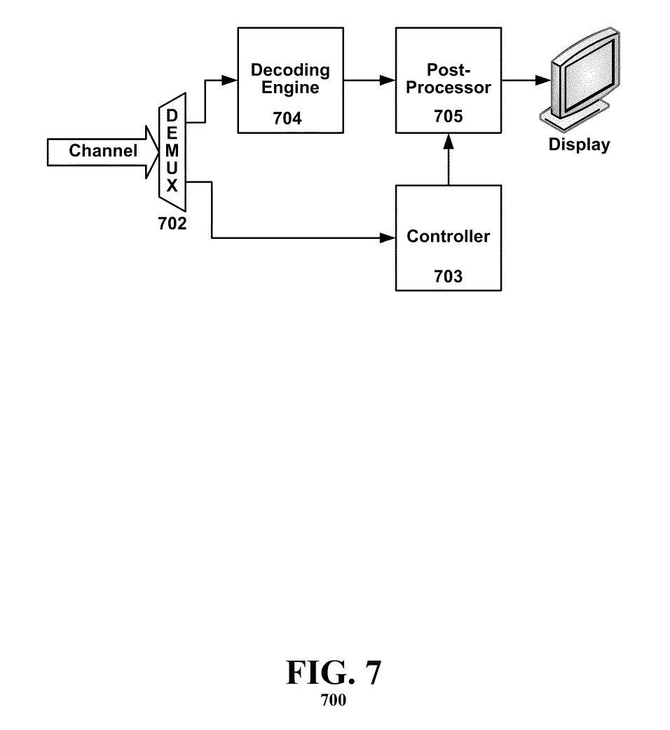

In another embodiment, shown in FIG. 7, the controller 703 may not set operating parameters or otherwise control the decoding engine 704. FIG. 7 is a simplified block diagram illustrating components of an exemplary video decoder according to an embodiment of the present invention. Similar to the decoder in FIG. 6, the decoder 700 may include a demultiplexer (DEMUX) 702, a decoding engine 704, a controller 703, and a post-processor 705.

As shown in FIG. 7, the controller 703 may receive frame instructions from the DEMUX 702 that indicate when the resolution has been switched. Then the controller 703 may have limited control of the post-processor 705 by setting operational parameters. For example, the controller 703 may set parameters setting the size of the effective viewing area to be displayed, the size of the frame available for display, or the pixel blocks that may be filled with constant black. However, the controller 703 may not have control of the decoding engine 704.

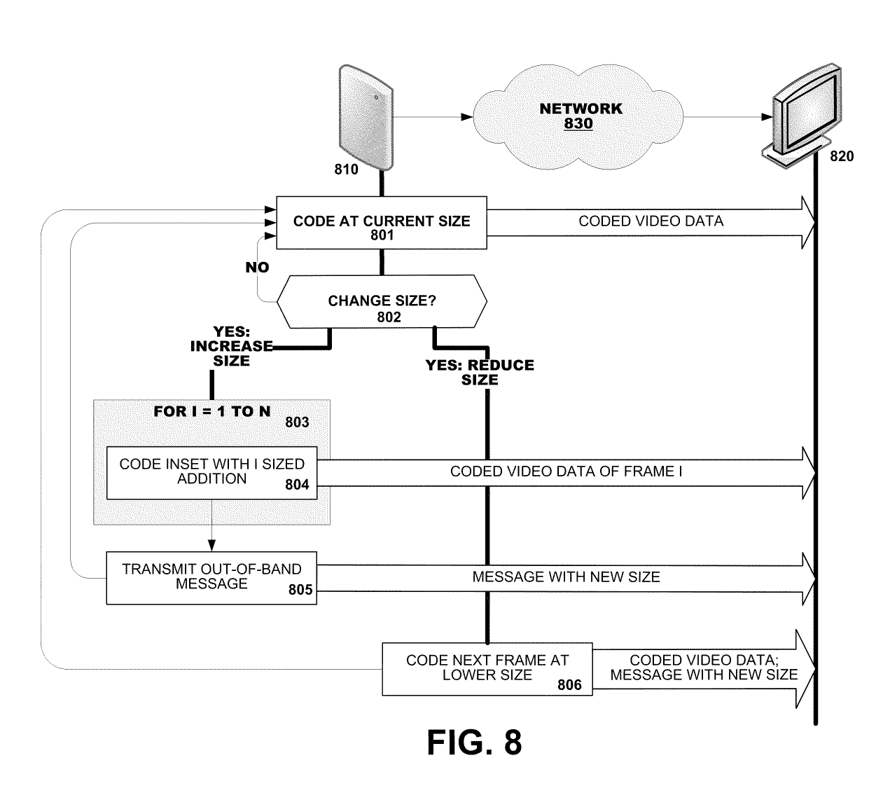

FIG. 8 is a simplified flow diagram illustrating coding video data with a resolution change according to an embodiment of the present invention. At block 801, video data may be coded at the encoder 810 and transmitted to the decoder 820 via the network or channel 830. As previously noted, the encoder 810 may separate received video data into frames. The frames may then be coded at the current size, with a consistent viewable image size. At decision block 802, a decision may be made as to whether to change the viewable image size and resolution. A resolution change may be initiated when it is detected that a change is needed to maintain image quality and transmission data rate. To determine that system conditions may warrant a resolution change, system coding statistics may be collected and analyzed. The collected coding statistics may include characteristics of the received video signal, statistics concerning the process of coding the video data, or the conditions of the output channel. Upon detection of conditions that would warrant a resolution change, the desired frame size and resolution may be determined. If no change is required, then the frames continue to be coded at the current size at block 801.

If it is determined at block 802 that the image size should be reduced, then at block 806 the next frame is coded at the smaller size. The encoder 810 may then communicate the new size to the decoder 820 using an out-of-band data channel of the channel 830. As previously noted, where the encoder 810 may operate according to the H.264 protocol, the new frame size may be transmitted in a supplemental enhancement information (SEI) channel specified by H.264. In another embodiment, the encoder 810 may include such frame instructions in a video usability information (VUI) channel of H.264. In yet another embodiment, if the encoder 810 may operate according to a protocol that does not specify out-of-band channels, the encoder 810 may establish a separate logical channel for the frame instructions within the output channel 830.

If it is determined at block 802 that the image size should be increased, then at block 803 a sequence of N frames may be encoded. For each frame in the sequence, pixel blocks scaled to the increased image size may be added at block 803 such that each frame may have an incrementally larger expansion image area than the previous frame, then at block 804 each frame, including the expansion image at the increased size and the effective image area at the original size, may be coded and transmitted to the decoder 820. The expansion image area is expanded with each subsequent frame until the combination of the expansion image area and the effective image at the original size reaches the desired increased image size. Then the effective image at the original size may be replaced by a portion of the received image scaled to the increased size such that every block in the frame contains image data at the increased size. The encoder 810 may then communicate the new size to the decoder 820 at block 805 via the channel 830.

A predetermined number of pixel blocks scaled to the increased size may be added to the expansion image area in each subsequent transition frame until the complete frame has been transitioned to the increased size. In another embodiment, the number of N frames to transition from the original image size to the desired increased image size may be predetermined, and the number of pixel blocks added in the expansion image area of each transition frames may be proportional to ensure that a complete image switch size may have occurred over the predetermined number of frames. For example, in an embodiment, the complete frame may transition from the original resolution to the desired resolution in 5-7 frames.

The foregoing discussion identifies functional blocks that may be used in video coding systems constructed according to various embodiments of the present invention. In practice, these systems may be applied in a variety of devices, such as mobile devices provided with integrated video cameras (e.g., camera-enabled phones, entertainment systems and computers) and/or wired communication systems such as videoconferencing equipment and camera-enabled desktop computers. In some applications, the functional blocks described hereinabove may be provided as elements of an integrated software system, in which the blocks may be provided as separate elements of a computer program. In other applications, the functional blocks may be provided as discrete circuit components of a processing system, such as functional units within a digital signal processor or application-specific integrated circuit. Still other applications of the present invention may be embodied as a hybrid system of dedicated hardware and software components. Moreover, the functional blocks described herein need not be provided as separate units. For example, although FIG. 2 illustrates the components of the encoder such as the controller 204, the MUX 205 and the communications manager 206 as separate units, in one or more embodiments, some or all of them may be integrated and they need not be separate units. Such implementation details are immaterial to the operation of the present invention unless otherwise noted above.

While the invention has been described in detail above with reference to some embodiments, variations within the scope and spirit of the invention will be apparent to those of ordinary skill in the art. Thus, the invention should be considered as limited only by the scope of the appended claims.

What is claimed is:

1. A video coding system, comprising:
a pre-processor to spatially scale frames of an input image signal to a programmable effective image size,
a coder to encode frames output from the pre-processor, and
a controller to provide parameters to the pre-processor defining the effective image size, wherein, when the effective image size is increased from a first size to a second size:
the pre-processor, over a plurality of frames, outputs composite frames formed from an effective image area having the input image signal scaled to fit the first size and an incrementally increasing expansion image area, each expansion image area having a portion of the input signal sized to fit the second size.

2. The video coding system of claim 1, wherein the composite frames further comprise an incrementally decreasing null image area.

3. The video coding system of claim 1, wherein the coder is an integrated circuit discrete from integrated circuit(s) of the pre-processor and controller, the coder operating on input frames of a fixed sized according to a locally-coded coding policy.

4. The video coding system of claim 1, wherein the coder operates on dynamically-sized input frames as determined by the controller.

5. A video coding method, comprising:
coding scaled frame data according to predictive coding techniques;
transmitting the coded frame data;
prior to the coding, spatially scaling frames of an input image signal according to a programmable effective image size, wherein the scaling comprises, when the effective image size is changed from a first size to a second, larger size, generating hybrid frames over a plurality of frames of the input image signal, each hybrid frame comprising:
an effective image area taken from the input image signal according to the first size, and
an incrementally increased expansion image area having image content taken from the input image signal and sized according to the second size; and
upon coding of a final hybrid frame among the plurality, transmitting an indicator of the second effective image size.

6. The method of claim 5, wherein
the coding operates on scaled frame data of a predetermined size (M×N) and,
when the scaling operates according to an effective image size lower than M×N, the scaling generates scaled frame data at the M×N size which includes an effective image area at the effective image size and null image content over a remainder of the M×N size.

7. A video encoding system comprising:
a pre-processor operable to create a plurality of frames from an input video signal; and
a coding engine operable to encode the plurality of frames;
wherein each frame has an effective image area at a first resolution and a null content area;
wherein for each successive frame in the plurality of frames, a block in the null content area is changed to a second resolution until all of the blocks in the null content area are at the second resolution, then changing the effective image area to the second resolution in a next frame.

8. The system of claim 7 further comprising a controller operable to detect the first resolution and the second resolution, and to transmit a resolution instruction to a decoder.

9. The system of claim 8 wherein the resolution instruction is sent to a decoder as out-of-band data on a communication channel.

10. The system of claim 7 further comprising a controller operable to detect when a change in resolution is to be initiated.

11. The system of claim 10 wherein said controller detects the change in resolution is to be initiated when the controller detects channel congestion at an output channel of the encoding system.

12. The system of claim 10 wherein said controller detects the change in resolution is to be initiated when the controller detects a change in the quality of the encoded frames.

13. The system of claim 10 wherein said controller detects the change in resolution is to be initiated when the controller detects a change in the input video signal.

14. The system of claim 7 wherein changing the effective image area to the second resolution further comprises upsizing a plurality of blocks from the effective image area to the second resolution.

15. A video decoding system comprising:
a decoding engine operable to decode a received video signal into a plurality of frames;
a post-processor operable to prepare the plurality of frames for display; and
a controller operable to receive a resolution instruction and to adjust the post-processor according to the instruction;
wherein the resolution instruction comprises resolution change information from a first resolution to a second resolution for a frame to be displayed;
wherein each successive frame in the plurality of frames contains an additional block at the second resolution.

16. The system of claim 15 wherein the resolution information comprises an effective image area for the frame.

17. The system of claim 16 wherein the post-processor prepares only the effective image area of the frame for display.

18. The system of claim 16 where the post-processor prepares a frame by changing a plurality of blocks outside the effective image area to a constant.

19. The system of claim 15 wherein the resolution instruction is received from an encoder as out-of-band data on a communication channel.

20. The system of claim 15 further comprising a controller operable to detect an incremental resolution change between frames and to set the resolution instruction.

21. A method of coding video comprising:
creating a plurality of frames from an input video signal, said creating including:
setting a plurality of pixel blocks in an effective image area of a frame in the plurality of frames to a first resolution;
for each successive frame in the plurality of frames, adding a pixel block to an area of the frame outside the effective image area at a second resolution; and
when all the pixel blocks outside the effective image area of a frame in the plurality of frames are at the second resolution, changing the pixel blocks of the effective image area to the second resolution;
coding the plurality of frames; and
transmitting the coded plurality of frames to a receiver on a communication channel.

22. The method of claim 21 further comprising creating the plurality of frames upon a detection that a resolution change from the first resolution to the second resolution is to be initiated.

23. The method of claim 22 wherein said detection further comprises detecting congestion on the communications channel.

24. The method of claim 22 wherein said detection further comprises detecting a change in the quality of the encoded frames.

25. The method of claim 21 further comprising transmitting a resolution instruction to the receiver.

26. The method of claim 21 wherein changing the pixel blocks of the effective image area to the second resolution comprises upsizing a plurality of pixel blocks in the effective image area.

27. A method of decoding video comprising:
decoding an encoded video signal from a received video signal;
receiving a resolution instruction concerning a change from a first resolution to a second resolution in the encoded video signal; and
preparing the plurality of frames for display in accordance with the resolution instruction;
wherein the encoded video signal comprises a plurality of frames, each successive frame in the plurality of frames having more pixel blocks at the second resolution than a previous frame.

28. The method of claim 27 wherein the resolution information comprises an effective image area for the plurality of frames.

29. The method of claim 28 wherein preparing a frame for display further comprises displaying only the effective image area of the frame.

30. The method of claim 28 wherein preparing a frame for display further comprises changing the area of the frame outside the effective image area to a constant and displaying the frame.
